(19) United States
(12) Patent Application Publication
(10) Pub. No.: US 2002/0066332 A1
(43) Pub. Date: Jun. 6, 2002

(54) Lock lever device for working implement drive control system of construction machine vehicle

(76) Inventor: Kazuo Horikawa, Komatsu-shi (JP)

Correspondence Address: VARNDELL & VARNDELL, PLLC, 106-A S. COLUMBUS ST., ALEXANDRIA, VA, 22314, US

(21) Appl. No.: 09/990,270

(22) Filed: Nov. 23, 2001

(30) Foreign Application Priority Data
Dec. 5, 2000 (JP) 2000-370241

(51) Int. Cl. G05G 1/04

(52) U.S. Cl. 74/491; 74/469

(57) ABSTRACT

A locking lever is enabled to lock a drive control system of a working implement in an undrivable state, even if it does not reach a locking stroke end. The locking lever is extended into a state to obstruct the passage into the passageway to a driver's seat thereby to switch a control selector lever of the working implement drive control system into a controllable position through a mechanical linkage. When the driver gets off from the driver's seat, the locking lever is returned from the passage obstructing position to a retracted position thereby to switch the control selector lever to an uncontrollable position through a the mechanical linkage. These operations are switched midway of the rocking stroke of the locking lever by bringing the control selector lever to the stroke end so that the locking lever is made idle to the stroke end of the retracted position while retaining the control selector lever in the switched state.

### BACKGROUND OF THE INVENTION

1. Field of the Invention

The present invention relates to a lock lever device of a working implement drive control system for locking/unlocking the drive control of the working implement of a construction machine vehicle such as bulldozer.

2. Related Art

The locking lever of the lock lever device of the working implement drive control system is disposed at a position to face the passageway to the driver's seat of the vehicle. When the locking lever is extended to block the passageway of the operator, the control selector lever of the drive control system is retained at the unlocked position. When the extended locking lever is retracted from the passageway, the control selector lever of the drive control system is switched to a locked position.

Moreover, the related art for locking/unlocking the drive control of the working implement is exemplified by those disclosed in Japanese Utility Model Laid-Open Nos. 12664/1987 and 97950/1992 and in Japanese Patent Laid-Open No. 30032/1992.

The drive uncontrollable locking means of the working implement drive control system oL the prior art includes either a circuit ON/OFF selector valve or a solenoid circuit ON/OFF selector valve in a fluid circuit connecting a pilot pressure control valve and a pilot fluid pressure source. The operation of the locking lever is connected in place of the motion of a mechanical linkage to a control selector lever for switching the action of the circuit ON/OFF selector valve or the solenoid circuit ON/OFF selector valve thereby to block the fluid circuit, so that the pilot fluid flow from the pilot fluid pressure source may be locked to block the flow of the pilot pressure fluid from the pilot pressure control valve to a working implement actuator control valve of the pilot pressure activated type thereby to lock the drive control of the working implement.

The locking lever and the control selector lever for switching the circuit ON/OFF selector valve or the solenoid circuit ON/OFF selector valve are linked through a mechanical linkage. It is, therefore, necessary to provide the mechanical linkage with an adjusting mechanism for the action transmission so that the locking lever and the control selector lever may have equal rocking strokes. This necessity complicates the construction of the mechanical linkage.

### SUMMARY OF THE INVENTION

Thus, this invention has an object to provide a lock lever device for a working implement drive control system of a construction machine vehicle. A locking lever is extended into a state to obstruct the passage into the passageway to a driver's seat thereby to switch a control selector lever of the working implement drive control system into a controllable position through a mechanical linkage. When the driver gets off from the driver's seat, the locking lever is returned from the passage obstructing position to a retracted position thereby to switch the control selector lever to an uncontrollable position through the mechanical linkage. From this lock lever device, there is eliminated the stroke equalizing adjust mechanism of the mechanical linkage linking the locking lever and the control selector lever.

In order to achieve the above-specified object, according to a first aspect of the invention, there is provided a lock lever device for a working implement drive control system of a construction machine vehicle, comprising: a locking lever; and a control selector lever linked to the locking lever for switching the working implement drive control system into a controllable or uncontrollable state by operating the locking lever, wherein the linkage linking the locking lever and the control selector lever includes an idle motion stroke mechanism for switching midway of the rocking stroke of the locking lever by bringing the control selector lever to a stroke end, to make the locking lever idle till the stroke end while holding the switching state of the control selector lever.

According to the first aspect of the invention, the working implement drive control system control selector lever acts associatively with the stroke action of the locking lever. When the control selector lever is switched to the ON/OFF position, however, the association with the locking lever is interrupted to make only the locking lever idle. With this linkage, therefore, it is possible to eliminate the stroke adjusting mechanism for the control selector lever over the entire stroke of the locking lever.

As a result, the construction of the linkage can be simplified, and the working implement drive control system can be reliably controlled and locked before the locking lever reaches the stroke end position.

In the first aspect of the invention, according to a second aspect, said linkage includes: an intermediate rocking lever link associated to follow the rocking motion of the locking lever; and a link rod for transmitting the rocking motion of the intermediate rocking lever link to the control selector lever, and the following association between the locking lever and the intermediate rocking lever link includes: a link mechanism engaging with an output lever rocking end for rocking integrally with the locking lever, so that the intermediate rocking lever link is pulled or pushed; and a link mechanism for quitting the pulling or pushing associated motion to make only the locking lever idle while retaining the intermediate rocking lever link at the rocking position.

According to the second aspect of the invention, the intermediate rocking lever link associated to follow the rocking motion of the locking lever is constructed of the rocking association mechanism for the intermediate rocking lever link to receive the rocking motion while following the rocking motion of the locking lever, and a rocking link mechanism for quitting the rocking association of the intermediate rocking lever link to make only the locking lever idle.

As a result, the control selector lever of the working implement drive control system can be switched midway of the rocking stroke of the locking lever, and the rocking stroke of the locking lever can be obtained even after the switching of the control selector lever, so that the rocking stroke to the extension of the locking lever to the passageway of the driver's seat and to the retraction can be made sufficient.

In the second aspect of the invention, according to a third aspect, the link mechanism for the intermediate rocking lever link to receive the pulling or pushing action therefrom and the link mechanism for making only the locking lever idle while retaining the intermediate rocking lever link at the rocking position are made of an engaging relation between an arcuate cam groove formed in the intermediate rocking lever link and a cam pin mounted at the output lever rocking end to rock integrally with the locking lever, and the arcuate cam groove for the cam pin to engage therewith includes: an action transmitting cam groove portion for following the rocking motion of the output lever rocking end to transmit the pulling or pushing action to the intermediate rocking lever link; and an inaction transmitting cam groove portion following the rocking locus of the output lever rocking end to prevent the rocking action of the output lever rocking end from being transmitted to the intermediate rocking lever link.

According to the third aspect of the invention, the cam pin at the locking lever rocking end to engage with the arcuate cam groove formed in the intermediate rocking lever link can apply, when it moves in the action transmitting cam groove, the pulling or pushing action to the intermediate rocking lever link to rock the same thereby to switch the control selector lever to the ON/OFF position. When the cam pin rocks in the inaction transmitting cam groove following the rocking locus of the locking lever rocking end, the rocking motion of the locking lever is not transmitted to the intermediate rocking lever link so that the locking lever can be left idle in the inaction transmitting cam groove.

As a result, even if the intermediate rocking lever link holds the working implement drive control system control selector lever at the ON/OFF position, it is possible to apply the rocking motion for keeping the locking lever idle to bring it to the stroke end, thereby to retain a necessary sufficient operation stroke from the extended position to the driver's seat passage way to the retracted position.

In the third aspect of the invention, according to a fourth aspect, moreover, the locking lever includes a toggle spring mechanism for biasing to rock the action transmitting cam groove portion and the inaction transmitting cam groove portion in opposite rocking directions of each other from a generally intermediate position of the cam groove portions.

According to the fourth aspect of the invention, the locking lever is biased to the rocking stroke end side and to the unrocking stroke end side by the toggle spring mechanism so that it can be stably positioned at the two stroke ends.

### BRIEF DESCRIPTION OF THE DRAWINGS

FIG. 1 is a structure explaining diagram showing an essential portion of the present invention;

FIG. 2 is a partially broken top plan view showing an essential portion of the present invention;

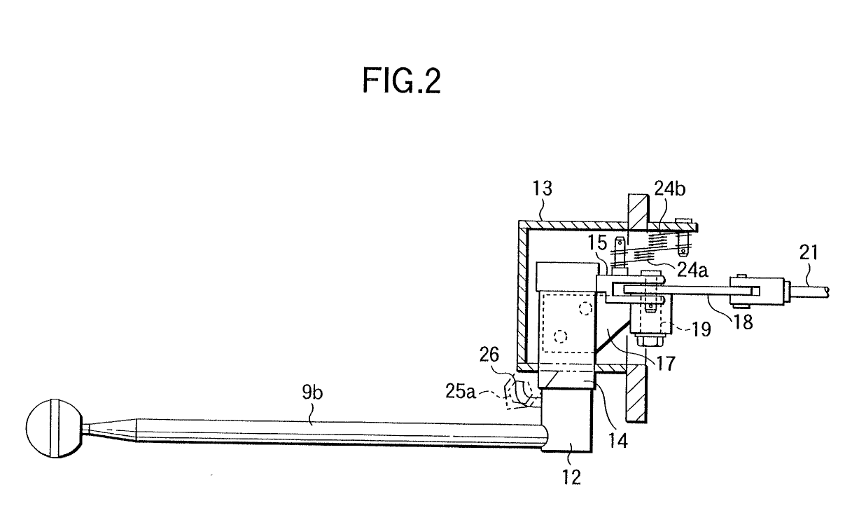

FIG. 3 is a perspective view showing an essential portion of the present invention;

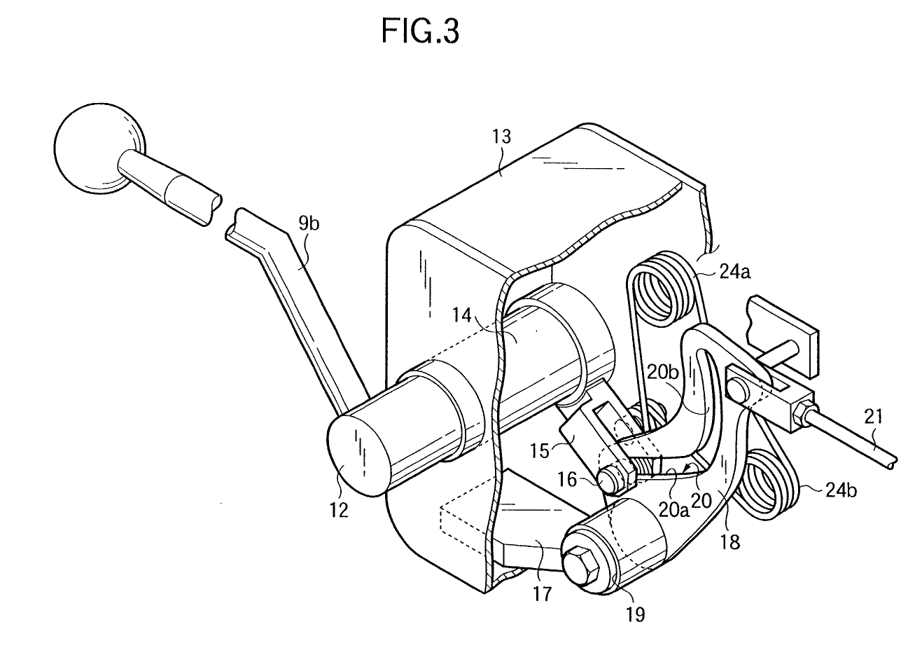

FIG. 4 is a diagram for explaining the actions of an intermediate rocking lever link;

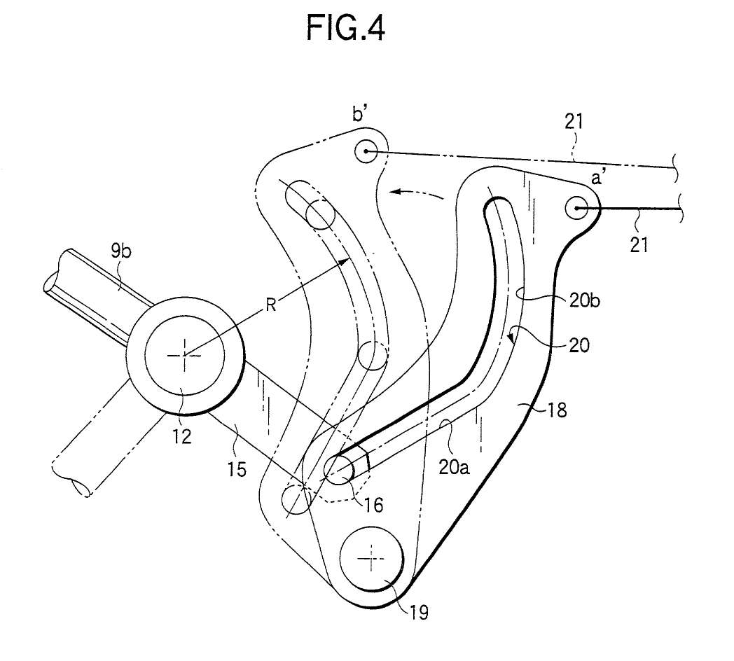

FIG. 5 is a side elevation of a bulldozer, to which the present invention is to be applied; and

FIG. 6 is a perspective view showing a portion of the periphery of a driver's seat of the bulldozer.

### DESCRIPTION OF THE PREFERRED EMBODIMENTS

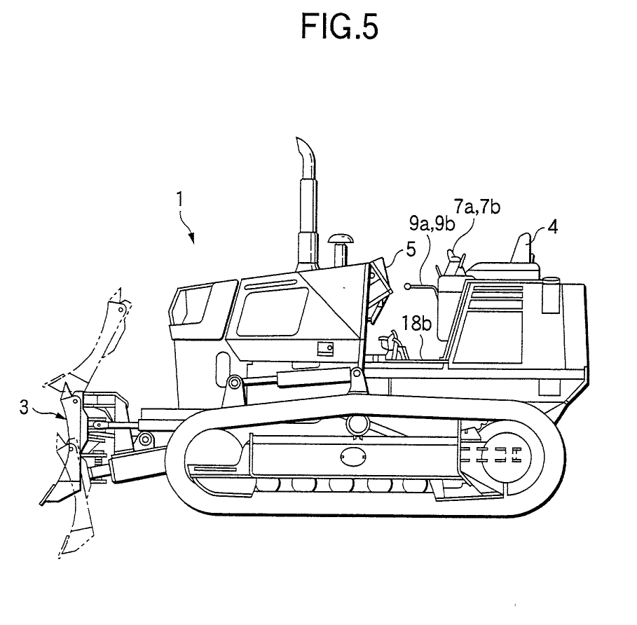

An embodiment of the present invention will be described with reference to the accompanying drawings. In FIG. 5: reference numeral 1 designates a bulldozer exemplifying a construction machine vehicle, to which the present invention is to be applied; numeral 2 a crawler type running mechanism; numeral 3 a working implement which is attached to the front side of the vehicle; numeral 4 a driver's seat; and numeral 5 a dash board disposed in front of the driver's seat 4. Between the driver's seat 4 and the dash board 5, there is placed a floor 6, which provides a passageway 6 to and from the driver's seat 4. On the two sides of the driver's seat 4 and at the dash board 5, there are arranged left and right maneuver levers 7a and 7b, a brake pedal 8 and so on for maneuvering the bulldozer 1.

On the two sides of the front of the driver's seat 4, moreover, there are disposed locking levers 9a and 9b which are rocked upward and downward to lock and unlock the drive control system of the bulldozer or working implement.

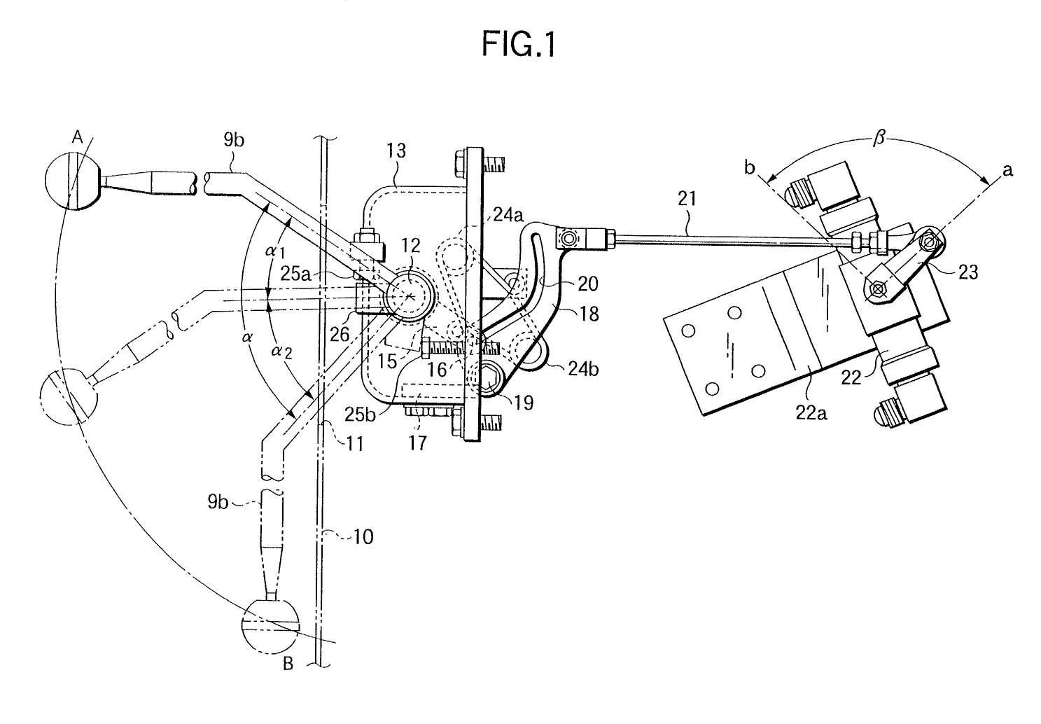

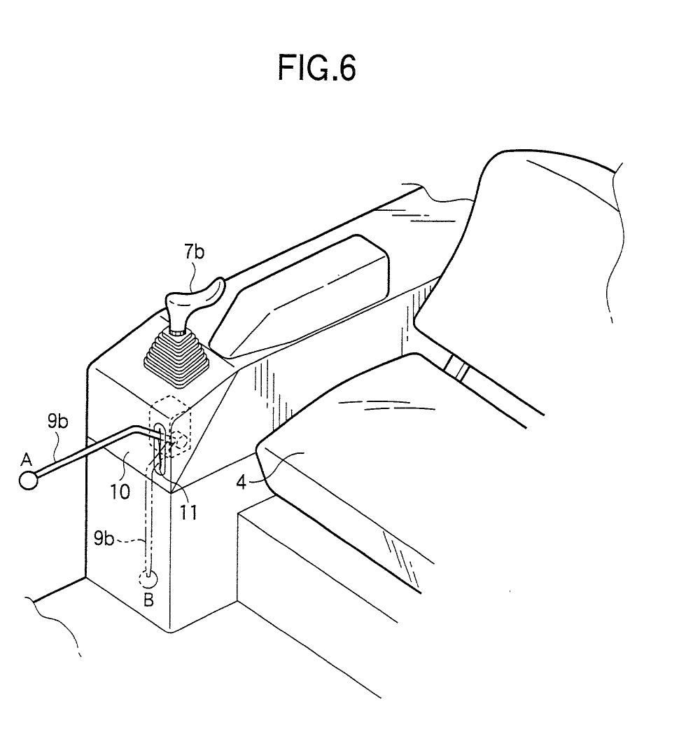

The locking lever 9a or 9b is vertically rocked, as shown in FIG. 1 and FIG. 6, downward from an extended position A crossing the driver's seat passageway 6 to a retracted position B retracted from the passageway 6. Moreover, the drive control system of the bulldozer or working implement is unlocked at the extended position A and is locked at the retracted position B.

A switch device for locking/unlocking the drive control system of the working implement is an pilot circuit ON/OFF selector valve 22 which is disposed in the pilot circuit of the drive system so that it can be switched by the action of a control selector lever 23 linked to the locking lever 9a or 9b.

The linkage for linking the locking lever 9a or 9b and the control selector lever 23 includes: an intermediate rocking lever link 18 associated to follow the rocking motion of the locking lever 9a or 9b; and a link rod 21 for transmitting the rocking motion of the intermediate rocking lever link 18 to the control selector lever 23.

To the locking lever 9a or 9b, there is fixed a turning lever pin 12, which is turnably supported at its intermediate portion by a bearing 14 mounted in a frame 13. Moreover, the turning lever pin 12 is equipped with a bifurcated output lever 15 which rocks integrally with the locking lever 9a or 9b.

The intermediate rocking lever link 18 is turnably attached at its one end to a support pin 19, which is arranged in parallel with the lever pin 12 on a bracket 17 mounted on the frame 13, so that it can rock in the same direction as that of the output lever 15.

The link rod 21 links the rocking leading end side of the intermediate rocking lever link 18 and the rocking leading end side of the control selector lever 23.

The bifurcated output lever 15 of the locking lever 9b and the intermediate rocking lever link 18 construct a following associated mechanism, in which the intermediate rocking lever link 18 follows the output rocking motion of the bifurcated output lever 15, to rock and quit the rocking motion.

The following associated mechanism includes: a cam pin 16 attached to the bifurcated output lever 15; and a cam groove 20 which is so formed in the intermediate rocking lever link 18 that the cam pin 16 may engage therewith.

The cam groove 20, as formed in the intermediate rocking lever link 18, is composed of: an action transmitting cam groove 20a which enables, when a rocking motion locus R of the cam pin 16 attached to the bifurcated output lever 15 does not coincide with the cam groove 20, the cam pin 16 to pull or push the cam groove 20 thereby to rock the intermediate rocking lever link 18 to follow the rocking motion locus R of the cam pin 16; and an inaction transmitting cam groove 20b which quits, when the rocking motion locus R of the cam pin 16 attached to the bifurcated output lever 15 coincides with the cam groove 20, the rocking motion of the intermediate rocking lever link 18 thereby to make the cam pin 16 and accordingly the locking lever 9b exclusively idle while retaining the intermediate rocking lever link 18 at the rocking motion quit position.

Moreover, both the action transmitting cam groove 20a for transmitting the pulling or pushing actions to the intermediate rocking lever link 18 while following the rocking motion of the output lever rocking end and the inaction transmitting cam groove 20b for preventing the rocking motion of the output lever rocking end from being transmitted to the intermediate rocking lever link 18 while following the rocking locus R of the output lever rocking end are formed into an arcuate continuous cam groove.

Thus, when the locking lever 9a or 9b is at the extended position A across the driver's seat passageway 6, the cam pin 16 takes the lowermost end of the action transmitting cam groove 20a to rock and position the intermediate rocking lever link 18 at the clockwise stroke end so that the pilot circuit selector valve 22 of the drive control system of the working implement may be held at position a, i.e., at an open position (in an unlocked state) by the link rod 21.

When the locking lever 9a or 9b is rocked from the aforementioned state (i.e., the extended position A) by a rocking angle α1 of about one half of the total rocking angle α thereof to bring the cam pin 16 into the action transmitting cam groove 20a, moreover, the intermediate rocking lever link 18 is pulled to follow and rock counter-clockwise of FIG. 1 so that the pilot circuit ON/OFF selector valve 22 of the drive control system of the working implement is turned by the link rod 21 over a turning angle β to position b thereby to switch the pilot circuit for driving the working implement to a closed position (in a locked state).

When this locked state is reached, moreover, the inaction transmitting cam groove 20b of the intermediate rocking lever link 18 having followed to rock is coincident with the rocking locus of the cam pin 16 attached to the end of the bifurcated output lever 15 of the locking lever 9a or 9b so that the cam pin 16 rolls in the inaction transmitting cam groove 20b. Therefore, the locking lever 9a or 9b does not pull the intermediate rocking lever link 18 but holds the pilot circuit ON/OFF selector valve 22 of the drive control system of the working implement at the position b in the locked state so that the locking lever 9a or 9b is made idle over a rocking angle α2 and confined at the retracted position B in which it is retracted from the passageway 6.

When the locking lever 9a or 9b is at this retracted position B, the cam pin 16 is positioned at the uppermost end of the inaction transmitting cam groove 20b to rock and position the intermediate rocking lever link 18 at the counter-clock stroke end position so that the pilot circuit ON/OFF selector valve 22 of the drive control system of the working implement is held at the position b, i.e., at the closed position (in the locked state) by the link rod 21.

When the locking lever 9a or 9b is rocked by the angle α2 from this state to restore the extended position to the passageway 6, the cam pin 16 only rolls in the inaction transmitting cam groove 20b of the intermediate rocking lever link 18 so that the locking lever 9a or 9b is idle not to follow and rock the intermediate rocking lever link 18 thereby to hold the pilot circuit ON/OFF selector valve 22 of the drive control system of the working implement at the position b, i.e., at the closed position (in the locked state). When the locking lever 9a or 9b comes into the region of the rocking angle α1, the cam pin 16 reaches the action transmitting cam groove 20a of the intermediate rocking lever link 18 to add the rocking motion to push the intermediate rocking lever link 18 clockwise so that the pilot circuit ON/OFF selector valve 22 of the drive control system of the working implement is switched from the position b to the position a by the link rod 21.

The locking lever 9a or 9b is provided with a toggle spring mechanism 24a or 24b for biasing to rock the cam pin 16 in the opposite directions of each other from a separation point of the rocking angles α1 and α2, i.e., from the intermediate portion of the intermediate rocking lever link 18 between the action transmitting cam groove 20a and the inaction transmitting cam groove 20b, so that the locking lever 9a or 9b is reliably positioned at the rocking motion stroke ends A and B.

At the separation point of the biasing directions, moreover, the locking lever 9a or 9b is made idle, and the pilot circuit ON/OFF selector valve 22 of the drive control system of the working implement is switched, so that the locking and unlocking operations can be reliably recognized.

This embodiment has been made by arranging the locking levers on the left and right sides, but the locking lever may be disposed on only one side, where the operator rides on to and gets off from the driver's seat.

In this embodiment, moreover, the lock switching device is exemplified by the circuit ON/OFF selector valve which is disposed in the pilot circuit of the drive control system of the working implement, but may be changed into a solenoid ON/OFF valve to be activated by an electric ON/OFF switch.

What is claimed is:

1. A lock lever device for a working implement drive control system of a construction machine vehicle, comprising: a locking lever; and a control selector lever linked to said locking lever for switching the working implement drive control system into a controllable or uncontrollable state by operating said locking lever,
wherein the linkage linking said locking lever and said control selector lever includes an idle motion stroke mechanism for switching midway of the rocking stroke of said locking lever by bringing said control selector lever to a stroke end, to make said locking lever idle till the stroke end while holding the switching state of said control selector lever.

2. A lock lever device according to claim 1,
wherein said linkage includes: an intermediate rocking lever link associated to follow the rocking motion of said locking lever; and a link rod for transmitting the rocking motion of said intermediate rocking lever link to said control selector lever, and
wherein the following association between said locking lever and said intermediate rocking lever link includes: a link mechanism engaging with an output lever rocking end for rocking integrally with said locking lever, so that said intermediate rocking lever link is pulled or pushed; and a link mechanism for quitting said pulling or pushing associated motion to make only said locking lever idle while retaining said intermediate rocking lever link at the rocking position.

3. A lock lever device according to claim 2,
wherein the link mechanism for said intermediate rocking lever link to receive the pulling or pushing action therefrom and the link mechanism for making only said locking lever idle while retaining said intermediate rocking lever link at the rocking position are made of an engaging relation between an arcuate cam groove formed in said intermediate rocking lever link and a cam pin mounted at the output lever rocking end to rock integrally with said locking lever, and
wherein the arcuate cam groove for said cam pin to engage therewith includes: an action transmitting cam groove portion for following the rocking motion of said output lever rocking end to transmit the pulling or pushing action to said intermediate rocking lever link; and an inaction transmitting cam groove portion following the rocking locus of said output lever rocking end to prevent the rocking action of said output lever rocking end from being transmitted to said intermediate rocking lever link.

4. A lock lever device according to claim 3,
wherein said locking lever includes a toggle spring mechanism for biasing to rock said action transmitting cam groove portion and said inaction transmitting cam groove portion in opposite rocking directions of each other from a generally intermediate position of said cam groove portions.
